(19) United States
(12) Patent Application Publication
(10) Pub. No.: US 2008/0180201 A1
(43) Pub. Date: Jul. 31, 2008

(54) Magnetic circuit

(76) Inventor: Eiji Sato, Fukuroi-Shi (JP)

Correspondence Address: WENDEROTH, LIND & PONACK, L.L.P., 2033 K STREET N. W., SUITE 800, WASHINGTON, DC, 20006-1021, US

(21) Appl. No.: 12/007,447

(22) Filed: Jan. 10, 2008

(30) Foreign Application Priority Data
Jan. 31, 2007 (JP) 2007-21749

(51) Int. Cl. H01F 7/128

(52) U.S. Cl. 335/278

(57) ABSTRACT

A magnetic circuit is provided which includes: a bottom yoke; a center pole disposed at the center of the front of the bottom yoke; a main magnet having a ring shape and disposed at the front of the bottom yoke; a top plate having a ring shape and disposed at the front of the main magnet; a repulsion magnet disposed at the rear of the bottom yoke; and a yoke cover disposed to cover the rear and side of the repulsion magnet, wherein the yoke cover has an outer diameter dimensioned equal to or smaller than the outer diameter of the main magnet, whereby the magnetic flux density at the air gap g can be enhanced. Thus, the magnetic circuit described above achieves an excellent magnetic efficiency.

### BACKGROUND OF THE INVENTION

1. Field of the Invention

The present invention relates to a magnetic circuit incorporable in a speaker.

2. Related Art

FIG. 9A is a schematic cross sectional view of a conventional complete shielded magnetic circuit 101, and FIG. 9B is an explanatory view of the right side of the magnetic circuit of FIG. 9A, showing magnetic fluxes flowing therein.

The complete shielded magnetic circuit 101 of FIG. 9A includes a bottom yoke 102, a center pole 103 disposed at the center of the front (upside in the figure) of the bottom yoke 102 so as to project frontward (upward in the figure), a main magnet 104 shaped annular and disposed at the front of the bottom yoke 102, an annular top plate 105 disposed at the front of the main magnet 104, a repulsion magnet 106 shaped annular and disposed at the rear of the bottom yoke 102, and a pot-shaped yoke cover 107 disposed to enclose the aforementioned constituent members, specifically, the bottom yoke 102, the center pole 103, the main magnet 104, the top plate 105, and the repulsion magnet 106.

In the shielded magnetic circuit 101 described above, leakage magnetic fluxes are shielded by means of the repulsion magnet 106 and the yoke cover 107, thus achieving a certain magnetic shielding effect. Under such circumstances, various approaches have been proposed for enhancing the magnetic shielding effect.

For example, a complete shielded magnetic circuit is disclosed and includes a bottom plate, a center pole disposed at the center of the front of the bottom plate so as to project frontward, a main magnet shaped annular and disposed at the front of the bottom plate, a top plate disposed at the front of the main magnet, and a cancellation magnet fixedly disposed at the rear of the bottom plate and magnetized with polarity reversed from that of the main magnet. In order to increase the effect of shielding leakage magnetic fluxes, the magnetic circuit further has a magnetic shield cover which is made of a magnetic material, and adapted to closely enclose the rear portion of the assembly of the aforementioned constituent members, and which is structured such that the thickness of a portion of the cover extending up to the front of the bottom plate is equal to or greater than the thickness of the thicker of the two; the bottom plate or the top plate is larger (refer to Japanese Utility Model Application Laid-Open No. H1-91395).

Also disclosed is a complete shielded magnetic circuit which includes a center pole, a first magnet shaped annular and disposed around the center pole, a front plate disposed at the front of the first magnet, a back plate disposed rearward of the first magnet and connected to the center pole, and a second magnet shaped annular, disposed close to the back plate and having the magnetization direction oriented opposite to that of the first magnet. In order to enhance the effect of reducing leakage magnetic fluxes, the magnetic circuit further includes a magnetic cover configured to cover the rear and circumferential side of the assembly made up of the aforementioned constituent members, and a magnetic member disposed inside the second magnet (refer to Japanese Patent Application Laid-Open No. H3-13200).

The complete shielded magnetic circuits disclosed by the aforementioned Japanese Patent Documents have basically the same structure as that of the complete shielded magnetic circuit 101 of FIG. 9A and have problems common to the shielded magnetic circuit 101. The problems will hereinafter be explained with reference to FIGS. 9A and 9B.

Referring to FIG. 9A, the yoke cover 107 is disposed outside the main magnet 104, and therefore the outer diameter of the shielded magnetic circuit 101 is inevitably increased by at least twice the thickness of the material of the yoke cover 107 compared to the outer diameter of the main magnet 104. Under such the circumstances, if the shielded magnetic circuit 101 has an upper limit to its outer diameter for space constraint, then the main magnet 104 faces an increased restriction and may be prohibited from having an adequate outer diameter, resulting in failure to achieve a high air gap flux density.

Also, the yoke cover 107 with a high permeability is disposed to entirely cover the main magnet 104 and the repulsion magnet 106 in order to enhance the shielding effect, and when the yoke cover 107 is located close to the main magnet 104 for the dimensional restriction or other reasons, magnetic flux lines φ2 which pass through the air gap between the top plate 105 and the yoke cover 107 are generated as well as magnetic flux lines φ1 which pass through the air gap between the top plate 105 and the center pole 103 as shown in FIG. 9B, and the amount of the magnetic flux passing through the air gap between the center pole 103 and the top plate 105 is decreased by the number of the magnetic flux lines φ2, thus lowering the air gap magnetic flux density.

### SUMMARY OF THE INVENTION

The present invention has been made in light of the problems described above, and it is an object of the present invention to provide a compact and inexpensive magnetic circuit in which a density of air gap magnetic flux can be increased while a magnetic shielding effect is maintained, and in which magnetic properties can be kept stable against temperature changes.

In order to achieve the object described above, according to an aspect of the present invention, a magnetic circuit is provided which includes: a bottom yoke; a center pole disposed at the center of the front of the bottom yoke; a main magnet having a ring shape and disposed at the front of the bottom yoke; a top plate having a ring shape and disposed at the front of the main magnet; a repulsion magnet disposed at the rear of the bottom yoke; and a yoke cover disposed to cover the rear and side of the repulsion magnet, wherein the yoke cover has an outer diameter dimensioned either equal to or smaller than the outer diameter of the main magnet.

Also, according to another aspect of the present invention, a magnetic circuit is provided which includes: a bottom yoke; a center pole disposed at the center of a front of the bottom yoke; a main magnet having a ring shape and disposed at the front of the bottom yoke; a top plate having a ring shape and disposed at the front of the main magnet; a repulsion magnet disposed at the rear of the bottom yoke; and a yoke cover disposed to cover the rear and side of the repulsion magnet and at least a part of the side of the main magnet, wherein the top plate has an outer diameter dimensioned either equal to or smaller than the outer diameter of the main magnet.

Thus, the present invention provides a compact and inexpensive magnetic circuit in which a density of air gap magnetic flux can be increased while a magnetic shielding effect is maintained, and in which magnetic properties can be kept stable against temperature changes.

### BRIEF DESCRIPTION OF THE DRAWINGS

FIG. 1A is a schematic cross sectional view of a magnetic circuit according to a first embodiment of the present invention, and FIG. 1B is an explanatory view of the right side of the magnetic circuit of FIG. 1A, showing magnetic fluxes flowing therein;

FIG. 2 is an explanatory view of one example of procedure for assembling the magnetic circuit of FIG. 1A;

FIG. 3 is a schematic cross sectional view of a magnetic circuit according to a second embodiment of the present invention;

FIG. 4 is an explanatory view of one example of procedure for assembling the magnetic circuit of FIG. 3;

FIG. 5A is a schematic cross sectional view of a magnetic circuit according to a third embodiment of the present invention, and FIG. 5B is an explanatory view of the right side of the magnetic circuit of FIG. 5A, showing magnetic fluxes flowing therein;

FIG. 6 is an explanatory view of one example of procedure for assembling the magnetic circuit of FIG. 5A;

FIG. 7A is partly a schematic cross sectional view of a magnetic circuit according to a fourth embodiment of the present invention, and FIG. 7B is a perspective view of a yoke cover of the magnetic circuit of FIG. 7A;

FIG. 8A is a schematic cross sectional view of a magnetic circuit according to a fifth embodiment of the present invention, and FIG. 8B is an explanatory view of the right side of the magnetic circuit of FIG. 8A, showing magnetic fluxes flowing therein; and

FIG. 9A is a schematic cross sectional view of a conventional complete shielded magnetic circuit, and FIG. 9B is an explanatory view of the right side of the magnetic circuit of FIG. 9A, showing magnetic fluxes flowing therein.

### DETAILED DESCRIPTION OF THE INVENTION

Exemplary embodiments of the present invention will hereinafter be described with reference to the accompanying drawings.

### First Embodiment

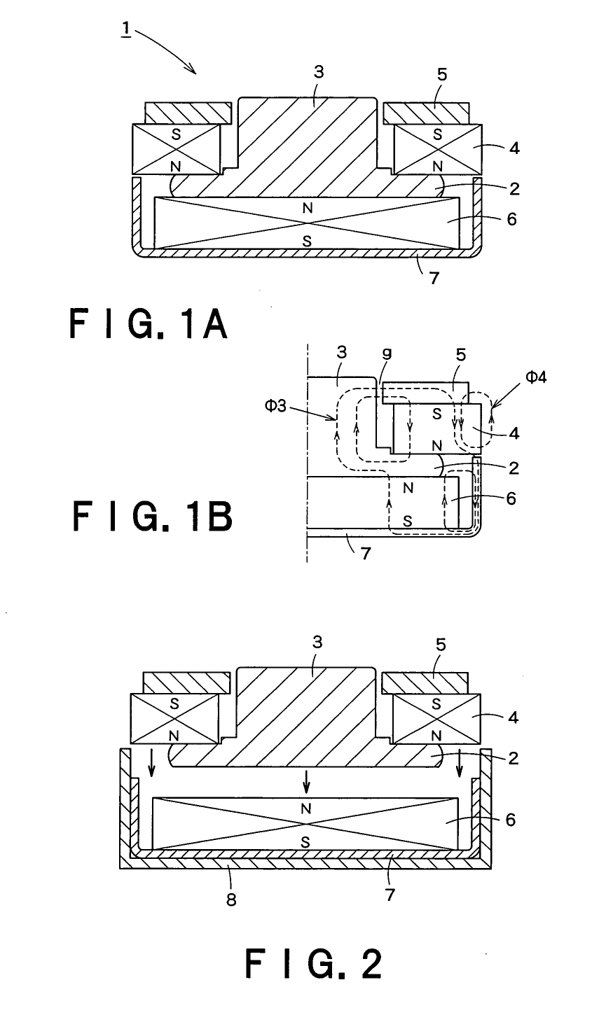

Referring to FIG. 1A, a magnetic circuit 1 according to a first embodiment of the present invention includes a bottom yoke 2, a center pole 3 disposed at the center of the front of the bottom yoke 2 so as to project frontward (upward in the figure), a main magnet 4 shaped into a circular ring and disposed at the front of the bottom yoke 2, a top plate 5 shaped into a circular ring and disposed at the front of the main magnet 4, a repulsion magnet 6 formed into a solid circular cylinder and disposed at the rear of the bottom yoke 2, and a yoke cover 7 formed into (for example in the figure) a pot-like configuration having a circular hollow cylinder portion and a bottom plate and disposed so as to cover the rear and side of the repulsion magnet 6.

While the outer diameter of the yoke cover 7 is set equal to the outer diameter of the main magnet in FIG. 1A, the yoke cover 7 may alternatively have a smaller outer diameter than the main magnet 4. The forefront of the yoke cover 7 may be positioned in contact with the rear of the main magnet 4 or positioned rearward thereof.

The top plate 5 has its outer diameter set smaller than the outer diameter of the main magnet 4 in FIG. 1A, but such an arrangement is not compulsory and the outer diameter of the top plate 5 may be set equal to the outer diameter of the main magnet 4.

Referring to FIG. 1B, many of the magnetic fluxes of the repulsion magnet 6 follow a magnetic path passing through the bottom yoke 2, the center pole 3, an air gap g, the top plate 5, the main magnet 4 and the yoke cover 7. An air, which has a low magnetic permeability, accounts for only a small portion of the magnetic path, and therefore magnetic flux lines φ3 having a low reluctance pass through the magnetic path. Consequently, a high air gap flux density is achieved.

Meanwhile, another magnetic path is formed at the outer circumferential portion of the main magnet 4, and magnetic flux lines φ4 caused by a leakage flux pass through this magnetic path. In the magnetic path with the magnetic flux lines φ4, a ratio of air with a low magnetic permeability is high. Therefore, the magnetic path has a high magnetic reluctance. Consequently, the magnetic flux lines φ4 have a lower magnetic flux than the magnetic flux lines φ2 described with reference to FIG. 9B.

If the forefront of the yoke cover 7 is located in contact with the rear of the main magnet 4, the reluctance near the contact area is lowered, and the number of the magnetic flux lines φ3 increases while the number of the magnetic flux φ4 decreases, consequently increasing the magnetic flux density of the air gap g. Thus, a higher air gap magnetic flux density is achieved when the yoke cover 7 is disposed in contact with the main magnet 4 than when not in contact therewith.

Referring now to FIG. 2, an example of a procedure for assembling the magnetic circuit 1 of FIG. 1A will be described.

The main magnet 4 is joined to the front of the bottom yoke 2, then the top plate 5 is joined to the front of the main magnet 4 (process S1). The repulsion magnet 6 is joined to the front of the bottom plate of the pot-like configuration of the yoke cover 7 (process S2) before, after, or in parallel with the process S1.

Then, an assembly tool 8 with positioning function is detachably set to the outer circumference of the yoke cover 7 (process S3). And, the assembly unit prepared at the process SI and made up of the bottom yoke 2, the main magnet 4 and the top plate 5 is put inside the assembly tool 8 such that the outer circumference of the main magnet 4 is guided by the inner circumference of the assembly tool 8 for a proper positioning between those constituent members while an adhesive is applied between the bottom yoke 2 and the repulsion magnet 6, whereby the rear of the bottom yoke 2 is adhesively joined to the front of the repulsion magnet 6 with the proper positioning ensured (process S4). Thus, the magnetic circuit 1 of FIG. 1A is completed.

The yoke cover 7 is made of a magnetic material, such as iron, and therefore the number of the magnetic flux lines φ3 becomes larger than the number of the magnetic flux lines φ4, thereby increasing the magnetic flux density of the air gap g between the center pole 3 and the top plate 5 as described above with reference to FIG. 1B.

The yoke cover 7 made of a magnetic material, however, is attracted toward the main magnet 4 by the magnetic force of the main magnet 4, which may possibly result in damaging the positioning between the yoke cover 7 and the bottom yoke 2 and the other constituent members. By using the assembly tool 8, the magnetic circuit 1 can be assembled without being affected by the magnetic force between the yoke cover 7 and the main magnet 4, thereby achieving a high positioning accuracy.

In the magnetic circuit 1 of FIG. 1A, since the outer diameter of the yoke cover 7 is set equal to or smaller than the outer diameter of the main magnet 4, the magnetic flux density of the air gap g can be increased and an enhanced magnetic efficiency can be achieved. Also, this structure that the outer diameter of the yoke cover 7 ranges only up to the outer diameter of the main magnet 4 is advantageous especially when the outer diameter of the magnetic circuit 1 is limited and the outer diameter of the main magnet 4 is desirably set as large as possible, because the outer diameter of the magnetic circuit 1, that is to say the entire diametrical size of the magnetic circuit 1 is defined not to exceed the maximized outer diameter of the main magnet 4 thus preventing an increase in the entire diametrical size of the magnetic circuit 1. Also, the outer diameter of the yoke cover 7 does not become larger than the outer diameter of the main magnet 4, thereby reducing the volume of the yoke cover 7 and reducing the material cost.

Further, the magnetic circuit 1 according to the present embodiment has the following advantages when compared to a simple shielded magnetic circuit, which has no yoke cover.

In the magnetic circuit 1 of FIG. 1A, many of the magnetic fluxes from the repulsion magnet 6 follow the magnetic path passing through the bottom yoke 2 and returning to the repulsion magnet 6, and since such the magnetic path in the magnetic circuit 1 includes an air with a low permeability in a smaller proportion than a magnetic path in a simple shielded magnetic circuit, the magnetic path of the magnetic flux lines φ3 shown in FIG. 1B has a lower reluctance than the magnetic path in the simple shielded magnetic circuit, thus achieving a high air gap magnetic flux density.

Also, the forefront of the yoke cover 7 in the magnetic circuit 1 is located in contact with or close to the rear of the main magnet 4, and the reluctance is decreased in the neighborhood of the contact or close area, whereby the magnetic flux lines φ4 of the main magnet 4, which become a leakage flux in the simple shielded magnetic circuit, are partly caused to flow in the yoke cover 7 as a part of the magnetic flux lines φ3, thereby increasing the air gap magnetic flux density. Therefore, the number of the magnetic flux lines φ4 is decreased, and the leakage flux is also reduced, which results in enhancing the magnetic shielding effect.

And, in the magnetic circuit 1, the magnetization of the yoke cover 7 is induced, whereby the demagnetizing field of the repulsion magnet 6 is caused to decrease, and the permeance coefficient of the repulsion magnet 6 is caused to increase, and consequently the repulsion magnet 6 of the magnetic circuit 1 has a higher operating point compared to a repulsion magnet of the simple shielded magnetic circuit. As a result, the magnetic circuit 1 is much less likely to be affected by demagnetization and can maintain stable magnetic properties against temperature changes (less demagnetization at high and low temperatures) compared to the simple shielded magnetic circuit.

As mentioned earlier, the forefront of the yoke cover 7 may be located flush with the rear of the main magnet 4 thus making contact therewith as shown in FIGS. 1A/1B or may alternatively be located rearward of the main magnet 4. Specifically, the forefront of the yoke cover 7 can be arbitrarily positioned between the rear of the main magnet 4 and the front of the repulsion magnet 6.

### Second Embodiment

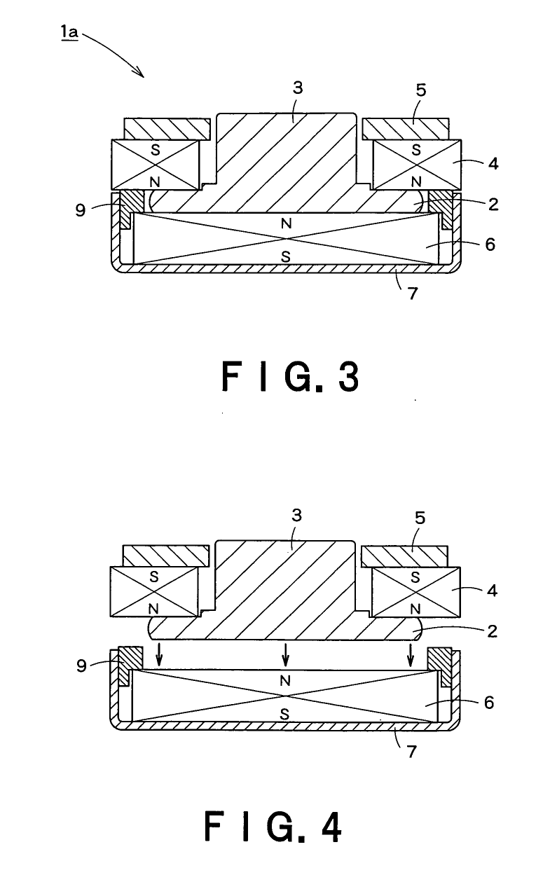

A second embodiment of the present invention will be described with reference to FIGS. 3 and 4. In FIG. 3 showing the second embodiment, any component parts corresponding to those in FIG. 1A are denoted by the same reference numerals, and a detailed description thereof will be omitted below.

Referring to FIG. 3, a magnetic circuit 1a according to the second embodiment differs from the magnetic circuit 1 of FIG. 1A according to the first embodiment only in that a spacer 9 is further included, and the descriptions to follow will be focused on the difference from the magnetic circuit 1 of FIG. 1A.

The spacer 9 is shaped annular, made of a non-magnetic material, such as resin, and provided at the inner circumference of the forefront part of a yoke cover 7.

The inner diameter of the spacer 9 is substantially equal to the outer diameter of a bottom yoke 2, whereby the bottom yoke 2 can be properly and securely positioned inside the yoke cover 7 by the spacer 9 working as a guide member. Also, the spacer 9 is made of a non-magnetic material and therefore is free from the influence of the magnetic force of a main magnet 4, whereby there is no possibility that the yoke cover 7 is absorbed to the main magnet 4.

Referring to FIG. 4, an example of a procedure for assembling the magnetic circuit 1a of FIG. 3 will be described. The main magnet 4 is joined to the front of the bottom yoke 2, then a top plate 5 is joined to the front of the main magnet 4 (process S5). A repulsion magnet 6 is joined to the front of the bottom plate of the yoke cover 7, and the spacer 9 is attached to the inner circumference of the yoke cover 7 (process S6) before, after, or in parallel with the process S5.

Then, the assembly unit prepared at the process S5 and made up of the bottom yoke 2, the main magnet 4 and the top plate 5 is joined to the assembly unit prepared at the process S6 and made up of the repulsion magnet 6, the yoke cover 7 and the spacer 9, such that the bottom yoke 2 is put inside the yoke cover 7 with the outer circumference of the bottom yoke 2 guided by the inner circumference of the spacer 9, and that the rear of the bottom yoke 2 is brought into contact with the front of the repulsion magnet 6 (process S7).

Thus, in the magnetic circuit 1a according to the second embodiment, since the spacer 9 is provided at the inner circumference of the forefront part of the yoke cover 7, the assembly unit including the bottom yoke 2 can be easily positioned without using the assembly tool 8 of FIG. 3 when joined to the repulsion magnet 6 set in the yoke cover 7. Also, the spacer 9 is made of a non-magnetic material and therefore is free from the influence of the magnetic force of the main magnet 5, thus avoiding difficulties during the assembling procedure.

The spacer 9 does not have to be a one-piece body shaped annular and may be composed of a plurality of discrete pieces separate from one another.

### Third Embodiment

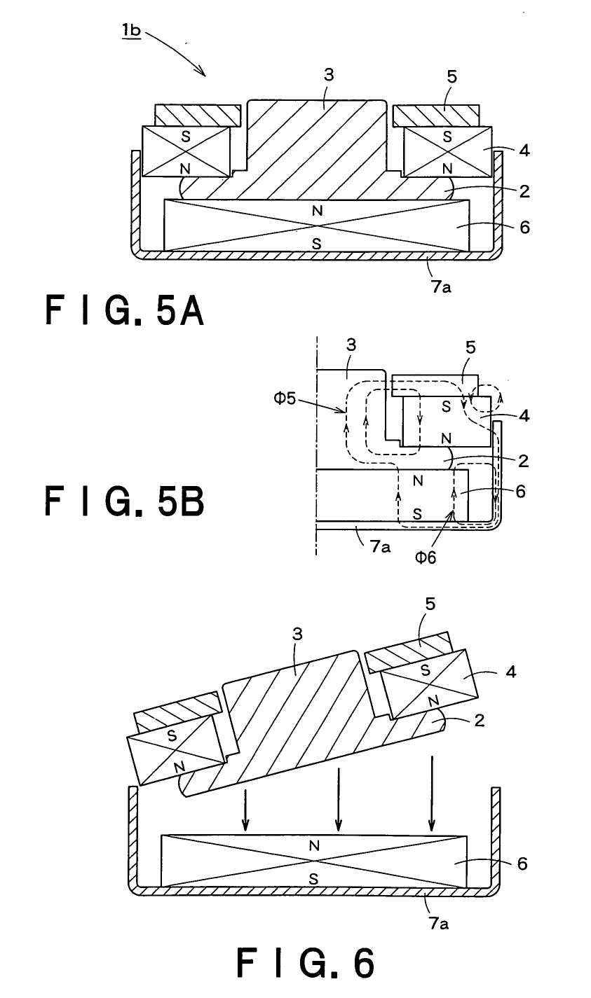

A third embodiment of the present invention will be described with reference to FIGS. 5A, 5B and 6.

In FIG. 5A showing a magnetic circuit 1b according to the third embodiment, any component parts corresponding to those in FIG. 1A are denoted by the same reference numerals, and a detailed description thereof will be omitted below with focus put on differences from the preceding embodiments.

The magnetic circuit 1b according to the third embodiment differs from the magnetic circuits 1 and 1a according to the first and second embodiments in the structure and disposition of a yoke cover. Specifically, referring to FIG. 5A, a yoke cover 7a of the magnetic circuit 1b is structured to have its inner diameter substantially equal to the outer diameter of a main magnet 4 and is disposed to partly enclose the main magnet 4 such that a part of the inner circumferential surface of the yoke cover 7a makes a close contact with a part of the outer circumferential surface of the main magnet 4. With this structure, magnetic flux lines φ5 are produced which follow a magnetic path passing through a repulsion magnet 6, a center pole 3, an air gap g, a top plate 5, the aforementioned main magnet 4, and the yoke cover 7a as shown in FIG. 5B. Since the yoke cover 7a and the main magnet 4 of FIG. 5A make contact with each other at a greater area than the yoke cover 7 and the main magnet 4 of FIG. 1A make contact with each other, the magnetic path for the magnetic flux lines φ5 of FIG. 5A has a lower reluctance than the magnetic path for the magnetic flux lines φ3 of FIG. 1A, and therefore the number of the magnetic flux lines φ5 can be increased.

Also, if the main magnet 4 and the repulsion magnet 6 of FIG. 5A have their respective outer diameters equal to the outer diameters of the main magnet 4 and the repulsion magnet 6 of FIG. 1A, the radial distance between the outer circumference of the repulsion magnet 6 and the inner circumference of the yoke cover 7a is increased by the thickness of the yoke cover 7a compared to the radial distance between the outer circumference of the repulsion magnet 6 and the inner circumference of the yoke cover 7, whereby the reluctance of the magnetic path from the repulsion magnet 6 to the yoke cover 7a is increased, thus decreasing the number of magnetic flux lines φ6, and the magnetic leakage due to the magnetic flux lines φ6 is reduced.

Referring to FIG. 6, an example of a procedure for assembling the magnetic circuit 1b of FIG. 5A will be described below. The main magnet 4 is joined to the front of the bottom yoke 2, then the top plate 5 is joined to the front of the main magnet 4 (process S8). The repulsion magnet 6 is joined to the front of the yoke cover 7 (process S9) before, after, or in parallel with the process S8. Then, the assembly unit prepared at the process S8 and made up of the bottom yoke 2, the main magnet 4 and the top plate 5 is set obliquely in the cover yoke 7 with a part of the outer circumference of the main magnet 4 disposed in contact with the inner circumferential edge of the forefront of the cover yoke 7a, and is slowly pushed obliquely into the-cover yoke 7a until the rear of the bottom yoke 2 is jointed to the front of the repulsion magnet 6 (process S10).

While the magnetic circuit 1b according to the third embodiment has its outer dimension increased compared with the magnetic circuit 1 according to the first embodiment, if the outer diameters of the main magnet 4 and the repulsion magnet 6 of the magnetic circuit 1b are set equal respectively to those of the magnetic circuit 1, then the number of the magnetic flux lines φ5 passing from the main magnet 6 to the yoke cover 7a is increased, thus increasing the air gap magnetic flux density. Also, in the magnetic circuit 1b, the number of the magnetic flux lines φ6 passing from the repulsion magnet 6 to the yoke cover 7a is decreased, thus achieving an enhanced magnetic shielding effect.

The forefront of the yoke cover 7a is positioned about at the middle of the main magnet 4 in FIG. 5A but may be positioned anywhere between the front and rear (inclusive) of the main magnet 4. Also, the inner circumferential surface of the yoke cover 7a is disposed in contact with the outer circumferential surface of the main magnet 4 in the above described example of the third embodiment but may alternatively be disposed close thereto, in which case the reluctance still can be lowered to some extent.

### Fourth Embodiment

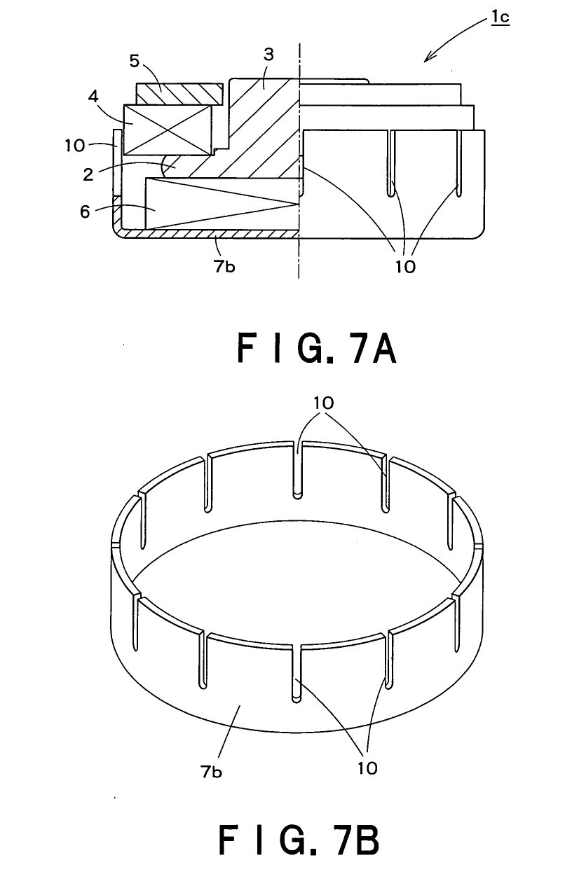

A fourth embodiment of the present invention will be described with reference to FIGS. 7A and 7B.

In FIG. 7A showing a magnetic circuit 1c according to the fourth embodiment, any component parts corresponding to those in FIG. 1A are denoted by the same reference numerals, and a detailed description thereof will be omitted below.

Referring to FIG. 7A, the magnetic circuit 1c according to the fourth embodiment is similar to the magnetic circuits 1b according to the third embodiment but differs therefrom in the structure of a yoke cover. Specifically, a yoke cover 7b of the magnetic circuit 1c includes one or more slits 10 formed at its forefront area, specifically the front end portion of the circular hollow cylinder, so as to extend rearward therefrom and has its inner diameter “slightly smaller than” (rather than “substantially equal to”) the outer diameter of a main magnet 4. In FIG. 7B, twelve of the slits 10 are disposed at a regular interval, but the present invention is not limited to such an arrangement, and the number, dimension and disposition interval of the slits 10 may be optimally determined.

The yoke cover 7b has its inner diameter slightly smaller inner diameter than the outer diameter of the main magnet 4, but since the slits 10 are formed at the forefront of the yoke cover 7b, when the main magnet 4 is inserted into the yoke cover 7b from the front end, the front end of the yoke cover 7b is forced open, whereby the main magnet 4 can be engagingly fitted into the yoke cover 7b.

Thus, since the main magnet 4 can be brought into a tight contact with the yoke cover 7b, the reluctance of the magnetic path passing between the main magnet 4 and the yoke cover 7b is effectively lowered, and therefore an enhanced air gap magnetic flux density can be achieved.

### Fifth Embodiment

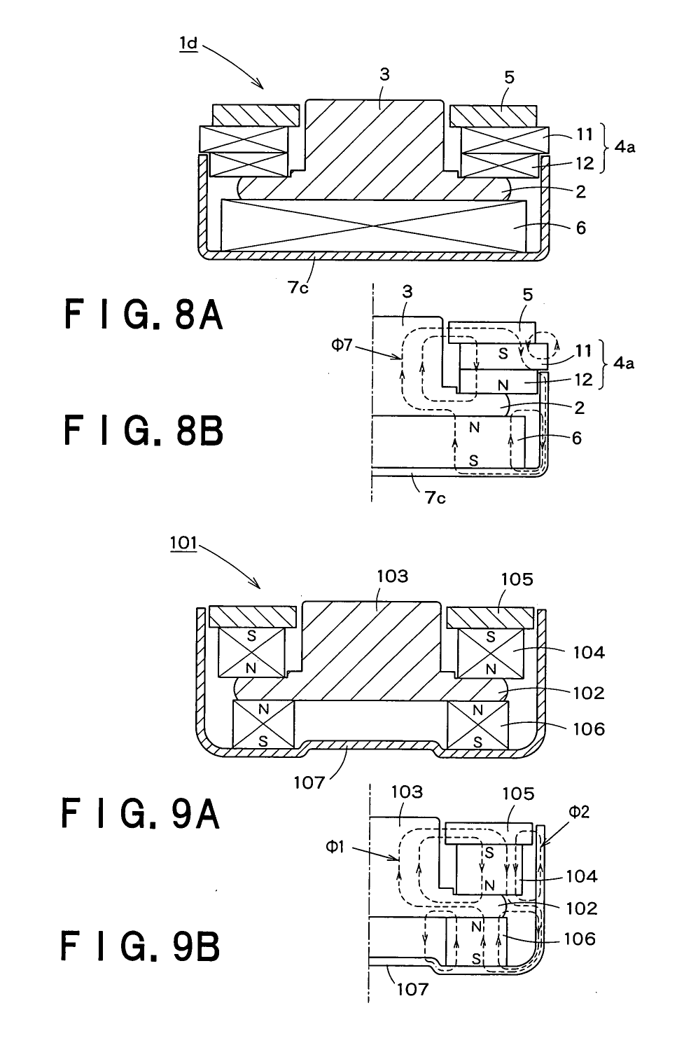

A fifth embodiment of the present invention will be described with reference to FIGS. 8A and 8B.

A magnetic circuit 1d according to the fifth embodiment shown in FIG. 8A is similar to the magnetic circuit 1b according to the third embodiment shown in FIG. 5A but differs therefrom in the structure of a main magnet. In explaining the example shown in FIG. 8A, any component parts common to FIGS. 5A and 8A are denoted by the same reference numerals, and a detailed description thereof will be omitted below with focus put on the difference.

Referring to FIG. 8A, a main magnet 4a of the magnetic circuit 1d includes a first segment 11 and a second segment 12 which is disposed in contact with the rear of the first segment 11, and which has a smaller outer diameter than the first segment 11. A yoke cover 7c of the magnetic circuit id has its inner diameter substantially equal to the outer diameter of the second segment 12 and smaller than the outer diameter of the first segment 11, and has its outer diameter set equal to the outer diameter of the first segment 11. The forefront of the yoke cover 7c is in contact with the rear of the first segment 11, and the inner circumferential surface of the yoke cover 7c located toward the forefront is in contact with the outer circumferential surface of the second segment 12.

The magnetic circuit Id of FIG. 8A is structured so that the forefront of the yoke cover 7c can be disposed in contact with the rear of the main magnet 4a (specifically the first segment 11 thereof as described above) which is common to the magnetic circuit 1 of FIG. 1A according to the first embodiment, and therefore the magnetic flux which has passed the first segment 11 of the main magnet 4a can be guided to the yoke cover 7c, whereby the magnetic flux density at an air gap g (refer to FIG. 8B) between a center pole 3 and a top plate 5 can be enhanced.

Also, in the magnetic circuit 1d, the inner circumferential surface of the yoke cover 7c can be disposed in contact with the outer circumferential surface of the main magnet 4a (specifically the second segment 12 thereof as described above) which is common to the magnetic circuit 1b of FIG. 5A according to the third embodiment, and therefore the magnetic flux which has passed the second segment 12 of the main magnet 4a can be guided to the yoke cover 7c, thereby enhancing the magnetic flux density at the air gap g. Since the main magnet 4a includes the first segment 11 which has its outer diameter oversized compared to the outer diameter of the main magnet 4 of the magnetic circuit 1b according to the third embodiment, the magnetic circuit 1d achieves a larger magnetomotive force than the magnetic circuit 1b. Specifically, the number of magnetic flux lines φ7, which follow a magnetic path passing through a repulsion magnet 6, the center pole 3, the air gap g, the top plate 5, the main magnet 4a, and the yoke cover 7c as shown in FIG. 8B, is increased to be larger than the number of the magnetic flux lines φ5 shown in FIG. 5B.

Thus, in the magnetic circuit id according to the fifth embodiment, a part of the main magnet 4a is enlarged, thereby enhancing the magnetic flux density at the air gap g without increasing the entire circuit dimension.

The forefront of the yoke cover 7c which is disposed in contact with the rear of the first segment 11 of the main magnet 4a in the fifth embodiment of FIG. 8A does not necessarily have to be in contact therewith and may alternatively be disposed close thereto. That is to say, the forefront of the yoke cover 7c may be disposed to be located between the front and rear (inclusive) of the second segment 12. Also, the inner circumferential surface of the yoke cover 7c does not necessarily have to be disposed in contact with the outer circumferential surface of the second segment 12 of the main magnet 4a and may alternatively be disposed close thereto. Also, the first segment 11 and the second segment 12 are discrete from each other in the fifth embodiment shown in FIG. 8A but may alternatively be integrally formed into one piece body.

While the present invention has been illustrated and explained with respect to specific embodiments thereof, it is to be understood that the present invention is by no means limited thereto but encompasses all changes and modifications that will become possible without departing from its spirit and scope.

For example, the repulsion magnet 6 does not necessarily have to be formed into a circular solid cylinder but may alternatively be formed into a ring shape. Also, the main magnet 4/4a and the top plate 5 do not necessarily have to be shaped into a circular ring but may have any ring shape, for example, an angular ring formed such that the center portion of an angulated configuration is hollowed out, and the yoke cover 7/7a/7b/7c may include a hollow cylinder portion configured according to the shape of the main magnet 4/4a.

What is claimed is:

1. A magnetic circuit comprising:
a bottom yoke;
a center pole disposed at a center of a front of the bottom yoke;
a main magnet having a ring shape and disposed at the front of the bottom yoke;
a top plate having a ring shape and disposed at a front of the main magnet;
a repulsion magnet disposed at a rear of the bottom yoke; and
a yoke cover disposed to cover rear and side of the repulsion magnet, the yoke cover having an outer diameter equal to or smaller than an outer diameter of the main magnet.

2. A magnetic circuit according to claim 1, wherein a forefront of the yoke cover is located between a rear of the main magnet and a front of the repulsion magnet.

3. A magnetic circuit according to claim 2, further comprising a spacer which is disposed at an inner circumference of the yoke cover to position the bottom yoke with respect to the yoke cover, and which is located at the rear of the main magnet.

4. A magnetic circuit according to claim 1, wherein the top plate has an outer diameter equal to or smaller than the outer diameter of the main magnet.

5. A magnetic circuit, the magnetic circuit comprising:
a bottom yoke;
a center pole disposed at a center of a front of the bottom yoke;
a main magnet having a ring shape and disposed at the front of the bottom yoke;
a top plate having a ring shape and disposed at a front of the main magnet;
a repulsion magnet disposed at a rear of the bottom yoke; and
a yoke cover comprising a hollow cylinder portion, the yoke cover being disposed to cover rear and side of the repulsion magnet and being disposed at least a part of a side of the main magnet, the top plate having an outer diameter equal to or smaller than the outer diameter of the main magnet.

6. A magnetic circuit according to claim 5, wherein the yoke cover has at least one slit at the hollow cylinder portion and is disposed in contact with the side of the main magnet.

7. A magnetic circuit according to claim 5, wherein the main magnet comprises a first segment and a second segment which is disposed in contact with a rear of the first segment and which has an outer diameter smaller than an outer diameter of the first segment, the yoke cover has an outer diameter equal to or smaller than the outer diameter of the first segment and greater than the outer diameter of the second segment, and wherein a forefront of the yoke cover is located between front and rear of the second segment.
